(19) United States
(12) Patent Application Publication
(10) Pub. No.: US 2026/0271165 A1
(43) Pub. Date: Sep. 10, 2026

(54) ADDRESS PROGRAMMING METHOD FOR LED BEADS, DEVICE, AND MEDIUM

(71) Applicant: GUANGDONG OPSCO TECHNOLOGY CO., LTD, Dongguan (CN)

(72) Inventors: MINGJIAN LIU, Dongguan (CN); GENGSHENG ZHU, Dongguan (CN)

(21) Appl. No.: 19/660,272

(22) Filed: Apr. 28, 2026

Related U.S. Application Data
(63) Continuation of application No. PCT/CN2024/134997, filed on Nov. 27, 2024.

(30) Foreign Application Priority Data
Jun. 6, 2024 (CN) 202410727481X

(51) Int. Cl. H05B 47/175

(52) U.S. Cl. CPC H05B 47/198

(57) ABSTRACT

This application discloses an address programming method and apparatus for LED beads, device and medium. The method includes: controlling the LED bead to emit light according to the initial address, and when an initial address corresponds to multiple LED beads that are emitting light, determining that the initial address is a duplicate address; replacing initial addresses of the multiple LED beads corresponding to the duplicate address with new initial addresses, such that each initial address corresponds to a single light-emitting LED bead; acquiring position information of each LED bead; generating the programmed address according to the position information, and programming the programmed address into the LED bead.

### CROSS-REFERENCE TO RELATED APPLICATIONS

The present disclosure claims priority of the Chinese Patent application No. 202410727481X entitled “ADDRESS PROGRAMMING METHOD FOR LED BEADS AND COMPUTER DEVICE” filed on Jun. 6, 2024, to the China National Intellectual Property Administration, the entire contents of which are incorporated herein by reference.

### FIELD

The present disclosure relates to the technical field of LED, and in particularly to an address programming method for LED beads and computer device.

### BACKGROUND

Integrated communication-class IC LED beads, characterized by long service life, zero pollution, and high luminous efficacy, are extensively employed in various illuminated display products. These IC LED beads are typically provided with control driver chips that regulate on/off states, color variations, and brightness modulation.

When IC LED beads are combined in series/parallel configurations, each IC LED bead generally requires address programming. In high-density integration products, probe-based address programming for single IC LED bead is often unfeasible. Instead, sequential address programming is adopted, with the LED beads addressed sequentially in the order of A→B→C→D→E, and so on. However, after the programming is completed, replacement of erroneously programmed beads proves cumbersome. It is necessary to confirm the specific address of the faulty bead, the programmer must be used to compare and confirm the corresponding positions one by one, and then replace the LED bead programmed the same address. This method impedes subsequent maintenance, reduces production/maintenance efficiency, increases upkeep costs, and compromises commercial viability.

### SUMMARY

This application provides an address programming method for LED beads and computer device, aiming to solve the problem that when the address resources of existing LED beads are excessively occupied, the verification efficiency of LED beads is too low and the cost increases significantly, resulting in low production efficiency and high upkeep costs for LED beads. The provided method enables the addresses within a plurality of LED beads to be arranged in an orderly manner, allowing for rapid identification and repair. It eliminates the need for dedicated equipment to complete address programming and replacement, thereby improving the production efficiency of LED beads and reducing their upkeep costs.

In a first aspect, this application provides an address programming method for LED beads. The method is used to program a programmed address into a plurality of LED beads mounted on a preset substrate, and each of the plurality of LED beads is pre-programmed with an initial address. The method includes:
controlling the LED bead to emit light according to the initial address, and when an initial address corresponds to multiple LED beads that are emitting light, determining that the initial address is a duplicate address;
replacing initial addresses of the multiple LED beads corresponding to the duplicate address with new initial addresses, such that each initial address corresponds to a single light-emitting LED bead;
acquiring image information of each LED bead during light emission, and acquiring position information of each LED bead relative to the preset substrate according to the image information; and
generating the programmed address of the LED bead according to the position information of the LED bead, and programming the programmed address into the LED bead according to the initial address of the LED bead.

In a second aspect, this application provides an address programming apparatus for LED beads, which is used to program a programmed address into a plurality of LED beads mounted on a preset substrate, and each of the plurality of LED beads is pre-programmed with an initial address. The apparatus includes:
a light-emitting control module, configured to control the LED bead to emit light according to the initial address, and when an initial address corresponds to multiple LED beads that are emitting light, determine that the initial address is a duplicate address;
an address replacement module, configured to replace initial addresses of the multiple LED beads corresponding to the duplicate address with new initial addresses, such that each initial address corresponds to a single light-emitting LED bead;
a position acquisition module, configured to acquire image information of each LED bead during light emission, and acquire position information of each LED bead relative to the preset substrate according to the image information; and
a second programming module, configured to generate a programmed address of the LED bead according to the position information of the LED bead, and program the programmed address into the LED bead according to the initial address of the LED bead.

In a third aspect, this application provides a computer device, which includes a processor and memory, the memory is configured to store a computer program, when the computer program is executed by the processor, the steps of the address programming method for LED beads provided by any embodiment of this application can be implemented.

In a fourth aspect, this application provides a computer-readable storage medium, wherein the computer-readable storage medium stores a computer program, when the computer program is executed by a processor, the processor is configured to implement the steps of the address programming method for LED beads provided by any embodiment of this application.

This application provides an address programming method for LED beads and computer device. In the method, random initial addresses are programmed into a plurality of LED beads, and then a plurality of LED beads are mounted on a preset substrate. When the LED beads are controlled to emit light according to the initial addresses and an initial address corresponds to multiple LED beads that are emitting light, the initial address is determined as a duplicate address; replace initial addresses of the multiple LED beads corresponding to the duplicate address with new initial addresses, such that each initial address corresponds to a single light-emitting LED bead; At this point, the position information of each LED bead relative to the preset substrate is acquired according to the image information of each LED bead during light emission, and a programmed address of the LED bead is generated according to the position information. Finally, the programmed address is programmed into the LED bead according to the initial address of the LED bead.

It should be understood that the above general description and the following detailed description are merely exemplary and explanatory, and shall not limit this application.

### BRIEF DESCRIPTION OF THE DRAWINGS

In order to clearly illustrate the technical solutions in the embodiments of this application, the following will briefly introduce the drawings used in the description of the embodiments. Apparently, the drawings in the following description are some embodiments of this application. For those of ordinary skill in the art, without making any creative efforts, other drawings can be obtained based on these drawings.

FIG. 1 is a schematic flow chart of an address programming method for LE beads provided by embodiments of this application.

FIG. 2 is a structural schematic diagram of an LED bead provided by embodiments of this application.

FIG. 3 is a schematic flow chart of an initial address programming method provided by embodiments of this application.

FIG. 4 is a schematic diagram of an address programming scenario provided by embodiments of this application.

FIG. 5 is a schematic block diagram of an address programming apparatus for LED beads provided by embodiments of this application.

FIG. 6 is a schematic block diagram of a computer device provided by embodiments of this application.

It should be understood that the above general description and the following detailed description are merely exemplary and explanatory, and shall not limit this application.

### DETAILED DESCRIPTION

The technical solution of embodiments of this application is clearly and completely described in detail in connection with the accompanying drawings. Apparently, described embodiments are some embodiments of this application, not all embodiments. Based on embodiments of this application, all other embodiments obtained by those of ordinary skill in the art without creative efforts are within the scope of this application.

The flow charts shown in the drawings are merely for illustrative purposes. They do not necessarily include all the content and operations/steps, nor do they have to be executed in the described order. For example, some operations/steps can be further split, combined, or partially merged, so the actual execution order may change according to the actual situation.

It should be understood that the terms used in the specification of this application are merely for the purpose of describing specific embodiments and are not intended to limit this application. As used in the specification of this application and the appended claims, unless the context clearly dictates, otherwise, the singular forms “a”, “an”, and “the” are intended to include the plural forms.

It should be understood that, in order to clearly describe the technical solutions of the embodiments of this application, in the embodiments of this application, terms such as “first” and “second” are used to distinguish identical or similar items with basically the same functions and effects. For example, the first marking information and the second marking information are only used to distinguish different data, and there is no limitation on their sequence. Those skilled in the art can understand that terms such as “first” and “second” do not limit the quantity or the execution order, and terms such as “first” and “second” do not necessarily mean that they are different.

It should be further understood that the term “and/or” used in the specification and the appended claims of this application refers to any combination and all possible combinations of one or more of the items listed in association, and includes these combinations.

The following is a detailed description of some embodiments of this application in connection with the accompanying drawings. In no conflicting situations, the embodiments and features within the embodiments described below can be combined with each other.

Integrated communication-class IC LED beads, characterized by long service life, zero pollution, and high luminous efficacy, are extensively employed in various illuminated display products. These IC LED beads typically are provided with control driver chips that regulate on/off states, color variations, and brightness modulation. Of course, communication-class driver chips support various driving methods, such as the commonly used single-line return-to-zero code integrated packaged IC LED beads, or double-line (backup signal) return-to-zero code integrated packaged IC LED beads. However, in the above solutions, for single-line return-to-zero code IC LED beads, once the signal line is disconnected, the cascaded driver IC LED beads behind cannot operate, resulting in the failure of the subsequent lighting of the product. As for double-line return-to-zero code IC LED beads with backup signals, they can only ensure that the subsequent cascading is not affected if one signal line between any two beads is disconnected, but they do not allow both signal lines of the same bead to be disconnected. Otherwise, the subsequent cascaded products will fail to light up. Therefore, there is a demand for IC LED beads with address codes, where the failure of any IC LED bead does not affect the operation of the subsequent beads, which work after decoding the internal address of the driver chip. The damage of any bead will not affect the operation of the subsequent beads. Accordingly, IC LED beads for parallel communication with address codes are required. For parallel IC LEDs, it is necessary to program an address code into each IC LED bead to ensure the normal operation of subsequent communication.

In some application schemes of LED beads, different IC LED beads are combined in series/parallel configurations, each IC LED bead generally requires address programming. In high-density integration products, probe-based address programming for single IC LED bead is often unfeasible. Instead, sequential address programming is adopted, with the LED beads addressed sequentially in the order of A→B→C→D→E, and so on. However, after the programming is completed, replacement of erroneously programmed beads proves cumbersome. It is necessary to confirm the specific address of the faulty bead, the programmer must be used to compare and confirm the corresponding positions one by one, and then replace the LED bead programmed the same address. This method impedes subsequent maintenance.

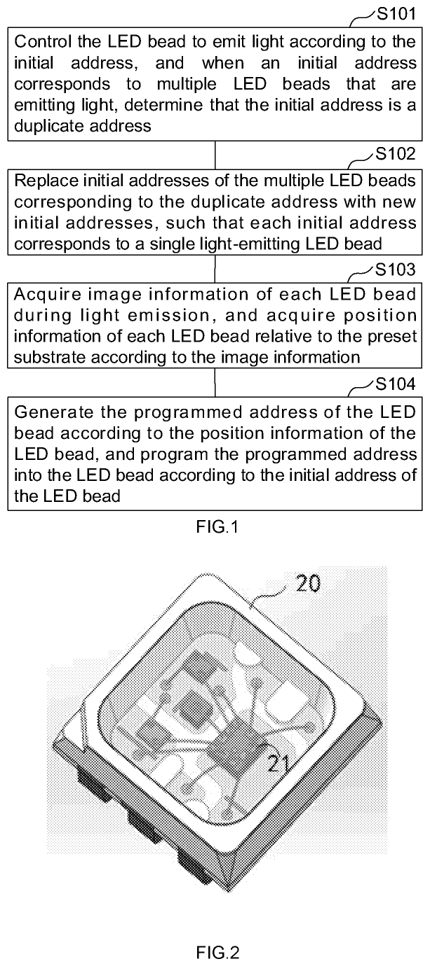

To solve the above problems, please refer to FIG. 1, FIG. 1 is a schematic flow chart of an address programming method for LED beads provided by embodiments of this application. The method is used to program a programmed address into the plurality of LED beads mounted on a preset substrate, and each LED bead is pre-programmed with an initial address. As shown in FIG. 2, the method is used to program the programmed address into a driver chip 21 of an LED bead 20.

In some embodiments, before controlling the LED bead to emit light according to the initial address, the method further includes: programming the initial address into the LED bead in a tape-out testing stage, circuit probing stage or final test stage during a preparation process of the LED bead.

The provided method programs the initial address corresponding to each LED bead individually during the tape-out testing stage or circuit probing (CP) stage, which are the pre-stage of final product; or it programs the initial address corresponding to each LED bead in the carrier tape individually during the final test (FT) stage, i.e., when the LED beads are being tape-packed. This facilitates subsequent verification of the validity of the initial addresses of the LED beads. This application does not limit the specific stage at which the initial address is programmed.

In some embodiments, the step of programming the initial address into the LED bead includes: during the CP stage of the LED bead, programming the initial address into a control chip of the LED bead on a wafer via probe contact; dicing the wafer into an individual-shaped control chip, and performing electrical connection and integrated packaging between the individual-shaped control chip and the light-emitting die of the LED bead, to form a package structure corresponding to the LED bead.

In the provided method, tape-out is first completed for the control chip of the LED bead, and then in the CP stage of the control chip, an initial address is programmed into the control chip through probe contact, wherein the initial address may be randomly selected from a preset initial address library or randomly generated. The wafer of the control chip with the initial address is ground and diced into an individual-shaped control chip, and then the individual-shaped control chip is integrated with the light-emitting dies (RGB dies) of the LED bead, to complete the electrical connection and package them into the required package structure. Then, the package structures of a plurality of LED beads are mounted on the preset substrate. Thus, the corresponding initial addresses can be quickly programmed into a plurality of LED beads, thereby ensuring the stable operation of the testing process in subsequent steps.

In some embodiments, in the final test stage of the LED bead, a plurality of the LED beads are packaged in carrier tape; the step of programming the initial address into the LED bead includes: in the final test stage of the LED bead, generating a plurality of initial addresses according to a second preset quantity; and programming the plurality of initial addresses into the plurality of LED beads packaged in carrier tape according to a preset order.

To simplify the efficiency of verifying the initial addresses of the LED beads, the initial addresses are programmed in descending or ascending order after testing and taping in the FT stage. Although the programming speed of the initial addresses is lower than that in the tape-out and CP stages, the wafer needs to be ground into individual-shaped control chips after address programming for the LED beads in the CP and tape-out stages, resulting in the disorder of the initial addresses of the LED beads even if programmed in order. Consequently, the LED beads in the final carrier tape package are out of order, leading to disordered addresses of the LED beads mounted on the preset substrate and a high probability of duplicate addresses. Meanwhile, if the individual-shaped control chips are mounted in order according to the initial addresses programmed in the LED beads during carrier tape packaging, the time cost will increase significantly. Programming the initial addresses into the LED beads in the carrier tape with PAD points as contact points in ascending or descending order in the FT stage can reduce the number of duplicate addresses of the LED beads on the preset substrate and improve the efficiency of duplicate address verification for the LED beads.

It should be noted that, in some embodiments, the step of programming the plurality of initial addresses into the plurality of LED beads packaged in carrier tape according to a preset order includes: programming the plurality of initial addresses into the plurality of LED beads packaged in carrier tape in descending order.

When a plurality of LED beads are packaged in carrier tape, address programming in descending order can make the start position of the carrier tape correspond to the maximum address, the LED beads are mounted on the preset substrate in ascending order of addresses, and the next reel of carrier tape is also mounted in this manner. Therefore, the number of duplicate addresses can be greatly reduced by programming the initial addresses in descending order and loading them into the carrier tape.

For example, for a plurality of LED beads, the initial addresses are first programmed into the LED beads in descending order (e.g., if the second preset quantity is 2000, the addresses are programmed from 2000 to 1), and then duplicate address verification and replacement are performed on the initial addresses subsequently, which can ensure the smooth operation of the provided method and improve the address programming speed for a plurality of LED beads. Thus, when the products are continuously mounted on the preset substrate, the reduction of duplicate addresses can be ensured.

In some embodiments, the provided preset substrate may be a PCBA board, a PCB board or a BT board, and the embodiments of this application imposes no limitation on the type of the preset substrate on which the LED beads are mounted.

It should be noted that the LED beads mounted on the preset substrate may be regularly distributed (e.g., from top to bottom or from left to right) or irregularly distributed (randomly mounted). This application can standardize the programmed addresses for different mounting forms of the LED beads to improve the communication efficiency with a plurality of LED beads.

As shown in FIG. 1, the provided address programming method includes the following steps.

In step 101, control the LED bead to emit light according to the initial address, and when an initial address corresponds to multiple LED beads that are emitting light, determine that the initial address is a duplicate address.

In some embodiments, the LED beads on the preset substrate can be controlled to emit light according to the initial addresses by recording and managing the programmed initial addresses or testing a plurality of initial addresses in the aforementioned initial address library one by one. Thus, the mounting process of the LED beads can be greatly simplified, that is, it is not necessary to ensure that the programmed address is correct when the LED beads are mounted, and even the situation of address missing (0 address) can be verified accordingly. Therefore, the provided method can improve the mounting and preparation efficiency of the LED beads. When the LED beads are controlled to emit light according to the initial addresses, if it is confirmed that multiple LED beads are in a light-emitting state by means of visual observation, visual detection, light source capture or bin sorting machine when controlling the LED bead corresponding to a certain initial address to emit light, the initial address is a duplicate address at this time, i.e., one initial address corresponds to multiple of LED beads. At this time, it is necessary to ensure that each initial address corresponds to only one LED bead to avoid duplicate addresses in the second address programming in the subsequent step.

In step 102, replace initial addresses of the multiple LED beads corresponding to the duplicate address with new initial addresses, such that each initial address corresponds to a single light-emitting LED bead.

In some embodiments, in the provided method, the initial addresses in the multiple LED beads corresponding to the duplicate addresses are replaced with new initial addresses, and then based on the new initial addresses, the corresponding LED beads are controlled to emit light, until each initial address corresponds to a single light-emitting LED bead, so as to ensure that each initial address corresponds to only one LED bead and avoid duplicate addresses in the subsequent address programming.

In some embodiments, please refer to FIG. 3, FIG. 3 is a schematic flow chart of an initial address programming method provided by embodiments of this application. As shown in FIG. 3, the step of replacing initial addresses of the multiple LED beads corresponding to the duplicate address with new initial addresses includes steps 102a to 102d.

In step 102a, send high-level instructions to host computer programs corresponding to the multiple LED beads, so that the multiple LED beads enter a duplicate address verification state.

In step 102b, send erase address instructions to the multiple LED beads corresponding to the duplicate address to erase initial addresses programmed in the multiple LED beads corresponding to the duplicate address.

In step 102c, regenerate new initial addresses which are different from initial addresses of the remaining LED beads with non-duplicate addresses.

In step 102d, program the new initial addresses into the multiple LED beads corresponding to the duplicate address.

To ensure that the addresses of the LED beads are not arbitrarily tampered with, only when high-level instructions are sent to the host computer programs corresponding to the multiple LED beads, driver chips of the LED beads are enabled to enter a duplicate address verification state, at which point the addresses stored in the LED beads can be erased and replaced. When it is confirmed that duplicate addresses exist in the initial addresses, leading to the problem of repeated encoding resources, the initial addresses corresponding to the duplicate address need to be reported, e.g., to the host computer programs responsible for generating and programming the initial addresses. After receiving the initial addresses which are duplicate addresses, the host computer programs first send high-level erase address instructions to the multiple LED beads corresponding to the duplicate address to erase the initial addresses to zero addresses. Then, new initial addresses are generated, wherein the new initial addresses are different from the non-duplicate initial addresses, and then the initial addresses of the LED beads with duplicate addresses are updated accordingly. This ensures that during the re-verification, new addresses of LED beads with duplicate addresses will not overlap with addresses of the LED beads confirmed to have no duplicate addresses in the previous verification, thus avoiding the problem of an incremental increase in the number of LED beads with duplicate addresses. Therefore, the provided method can ensure that there are no duplicate address among a plurality of LED beads mounted on the preset substrate.

In some embodiments, the step of regenerating new initial addresses includes: controlling a voltage oscillation of an address generator corresponding to the initial address to change an operating frequency of the address generator, so as to generate different initial addresses when the address generator is powered on. Therefore, the method provided by this application can realize real-time voltage oscillation of the address generator corresponding to the initial address under a high-level instruction, and complete the replacement of the initial address without powering off the address generator. This not only improves the speed of address replacement but also avoids the problem of low efficiency of duplicate address verification caused by the same initial address between the replaced LED bead and the LED beads without duplicate addresses.

In some embodiments, before replacing initial addresses of the multiple LED beads corresponding to the duplicate address with new initial addresses, the method further includes: acquiring image information of a single light-emitting LED bead corresponding to a non-duplicate initial address during light emission, and acquiring position information of the LED bead with a non-duplicate address relative to the preset substrate according to the image information; and generating the programmed address for the LED bead according to the position information of the LED bead with the non-duplicate address, and programming the programmed address into the LED bead according to the initial address of the LED bead with the non-duplicate address, to make the initial address the same as those of the remaining LED beads.

After completing the duplicate address verification for a plurality of LED beads, the programmed address can be determined for the LED bead with a non-duplicate address according to its position information first, for example, the programmed address is determined according to the position in an order from front to back, top to bottom or any other arrangement mode. In this way, new initial addresses subsequently programmed into the LED beads with duplicate addresses can be randomly generated, improving the speed of replacing duplicate addresses.

It should be noted that after performing two address-programming operations on the LED beads with non-duplicate addresses, the initial address can also be regenerated by first powering off the address generator, changing the operating voltage of the address generator to alter its frequency, and then controlling the address generator to power on again so that it generates a new initial address, for example, by changing the voltage from 5V to 5.1V, and then powering on the address generator again, the initial address of the LED bead with the duplicate address is replaced, thereby completing the duplicate address verification for it. At this time, the provided method can still be implemented even if the replaced initial address of the LED bead with the duplicate address is the same as the initial address of the LED bead with a non-duplicate address.

In step 103, acquire image information of each LED bead during light emission, and acquire position information of each LED bead relative to the preset substrate according to the image information.

In some embodiments, when controlling each LED bead to emit light according to its corresponding initial address, the image information of each LED bead during light emission is acquired, and the position information of the light-emitting LED bead in each image can be extracted by means of image recognition technology, and then the initial address can be associated with the position information, so as to accurately locate each LED bead on the preset substrate.

In some embodiments, the step of acquiring image information of each LED bead during light emission includes: controlling an image acquisition device to face the preset substrate for imaging, in order to acquire image information when controlling each LED bead to emit light according to its corresponding initial address. By synchronously controlling the image acquisition device to capture the image of the preset substrate while controlling each LED bead to emit light, the image information of each LED bead during light emission can be acquired to determine the positions of a plurality of LED beads.

It should be noted that when acquiring the image information of each LED bead during light emission, the preset substrate can be placed in a dark chamber, so that the image information can reflect the position information of the light-emitting LED beads more accurately.

In step 104, generate the programmed address of the LED bead according to the position information of the LED bead, and program the programmed address into the LED bead according to the initial address of the LED bead.

In some embodiments, a programmed address for the LED bead is generated according to its position information, and then the programmed address is programmed into the corresponding LED bead according to the initial address. For example, the host computer program corresponding to the LED bead is controlled to enter a preset high-level mode that supports address replacement; under the high-level mode, the initial address of the LED bead is erased and the corresponding programmed address is programmed instead, so as to replace the address of the LED bead with a position-arranged programmed address. This can reduce the waste of address resources, reduce the device size of the LED bead, lower the hardware cost, and also improve the communication efficiency of the LED bead.

In some embodiments, the step of generating the programmed address of the LED bead according to the position information of the LED bead includes: sorting position information corresponding to a plurality of LED beads in a preset order; generating a plurality of sequentially arranged programmed addresses according to a first preset quantity; wherein the first preset quantity is the total number of a plurality of LED beads, or the first preset quantity is a preset threshold, and the preset threshold is less than the total number of a plurality of LED beads.

When a plurality of LED beads, such as 2000 beads, are sorted in a preset order such as from top to bottom, left to right or any other preset order, the method provided herein can generate programmed addresses for a plurality of LED beads by taking the total number of the LED beads as the first preset quantity. Meanwhile, to save address resources, the first preset quantity can be much smaller than the total number of the LED beads. For example, the total number of LED beads is 2000 and the first preset quantity is 300, the first preset quantity of the programmed addresses is programmed into a plurality of LED beads sequentially in ascending or descending order, thereby saving the address resources of a plurality of LED beads.

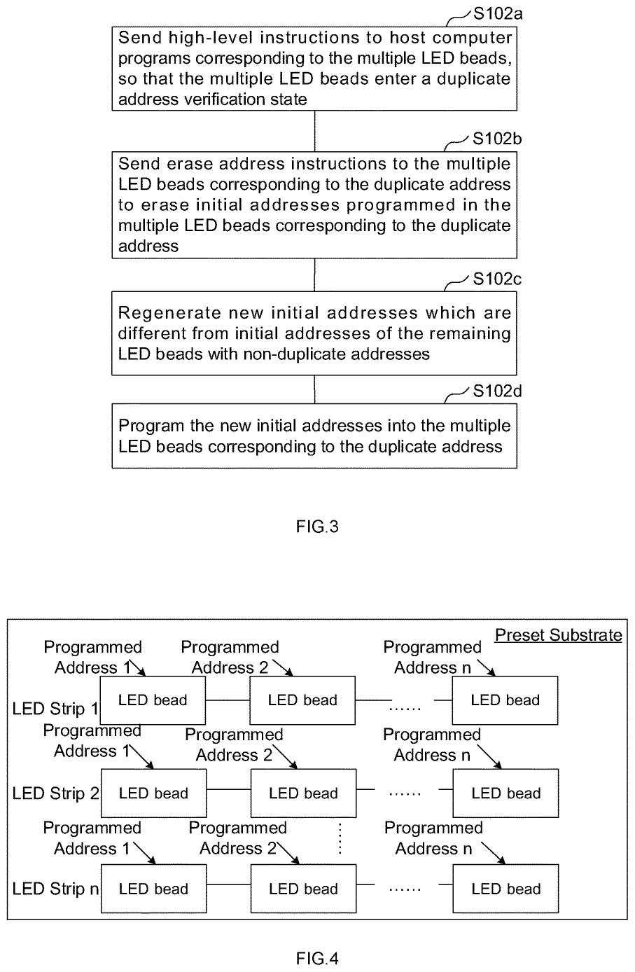

In some embodiments, as shown in FIG. 4, FIG. 4 is a schematic diagram of an address programming scenario provided by embodiments of this application. The preset substrate includes a plurality of LED strips arranged side by side, and each LED strip includes at least two LED beads. The step of generating the programmed address of the LED bead according to the position information of the LED bead includes: sorting the position information of the at least two LED beads corresponding to the LED strip in the preset order; generating a plurality of sequentially arranged programmed addresses according to the first preset quantity; wherein the first preset quantity is the total number of the at least two LED beads in the LED strip, or the first preset quantity is the preset threshold, wherein the preset threshold is less than the total number of the at least two LED beads in the LED strip; the programmed addresses are programmed into the at least two sorted LED beads of each LED strip according to the initial addresses.

As shown in FIG. 4, when there are a plurality of LED strips (such as LED strip 1 to LED strip n in FIG. 4), programming the same programmed address into the LED beads at the same relative position of each LED strip can ensure the consistent address arrangement of the finally produced LED beads and simplify the control logic for the LED beads. Certainly, the programming order of the addresses of the LED beads can be adjusted as required based on the method provided by this application, for example, the programming order of the programmed address of LED strip 1 is reversed relative to that of LED strip 2, which is not limited in the embodiments of this application.

In some embodiments, before sorting position information corresponding to the plurality of LED beads in a preset order, the method further includes: acquiring an arrangement corresponding to a plurality of LED beads according to their position information; and determining a preset order corresponding to a plurality of LED beads according to the arrangement.

The arrangement of the LED beads may be regular or irregular according requirements. This application first analyzes the position information to obtain the arrangement corresponding to a plurality of LED beads, and then extracts the corresponding preset order. For example, the coordinates corresponding to the position information of a plurality of LED beads are input into a preset order prediction model, which is used to output the corresponding arrangement and preset order according to the position information of a plurality of LED beads. Wherein the order prediction model can be any artificial intelligence model, and the type of the order prediction model is not limited in the embodiments of this application.

In some embodiments, the step of programming initial addresses into a plurality of LED beads includes: programming an initial address and first marking information into the LED bead; wherein the first marking information is located at the head or the tail of the initial address. The step of programming the programmed address into the LED bead according to the initial address of the LED bead includes: programming the programmed address and second marking information into the LED bead according to the initial address of the LED bead; wherein the second marking information is located at the head of the initial address or the tail of the programmed address. To distinguish the initial address from the programmed address, this application adds corresponding first marking information or second marking information at the head or tail of the address information, which facilitates the address management.

In some embodiments, the step of programming the programmed address into the LED bead according to the initial address of the LED bead includes: programming the programmed address and a backup address corresponding to the programmed address into the LED bead according to the initial address of the LED bead.

If the programmed address fails to be programmed into the LED bead, the LED bead on the preset substrate needs to be removed, resulting in a very complicated process and a sharp increase in cost. Therefore, this application programs the programmed address into the corresponding backup address in the LED bead, wherein the content of the backup address is the same as that of the programmed address. Thus, the control of the LED bead can be completed as long as either the programmed address or its backup address takes effect.

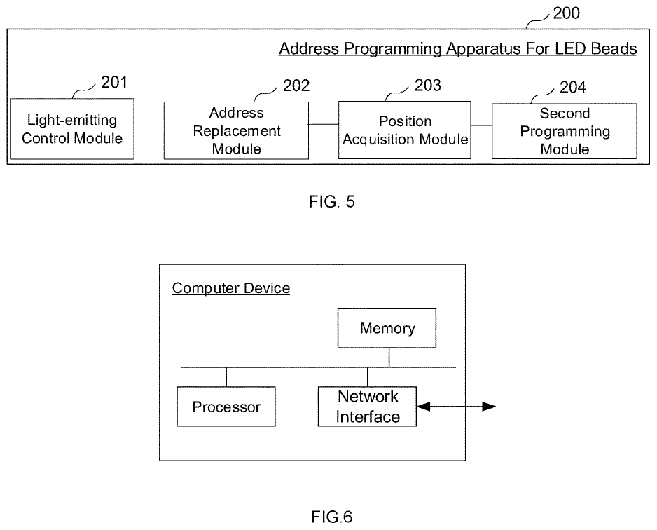

This application provides an address programming apparatus 200 for LED beads, which is used to program a programmed address into a plurality of LED beads mounted on a preset substrate, and each LED bead is pre-programmed with an initial address. As shown in FIG. 5, FIG. 5 is a schematic block diagram of an address programming apparatus for LED beads provided by embodiments of this application. Wherein the address programming apparatus for LED beads can be configured in the server.

As shown in FIG. 5, the address programming apparatus 200 for LED beads includes a light-emitting control module 201, an address replacement module 202, a position acquisition module 203 and a second programming module 204.

The light-emitting control module 201 is configured to control the LED bead to emit light according to the initial address, and when an initial address corresponds to multiple LED beads that are emitting light, determine that the initial address is a duplicate address.

The address replacement module 202 is configured to replace initial addresses of the multiple LED beads corresponding to the duplicate address with new initial addresses, such that each initial address corresponds to a single light-emitting LED bead.

The position acquisition module 203 is configured to acquire image information of each LED bead during light emission, and acquire position information of each LED bead relative to the preset substrate according to the image information.

The second programming module 204 is configured to generate the programmed address of the LED bead according to the position information of the LED bead, and program the programmed address into the LED bead according to the initial address of the LED bead.

It should be noted that those skilled in the art can clearly understand that, for the sake of convenience and conciseness of description, the specific working process of the apparatus and each unit described above can refer to the corresponding process in the embodiments of foregoing method, and will not be repeated here.

The apparatus described above may be implemented in the form of a computer program, which can run on a computer device as shown in FIG. 6.

This application provides a computer device. As shown in FIG. 6, FIG. 6 is schematic block diagram of a computer device provided by embodiments of this application.

Wherein the computer device can include a processor, a memory, and a network interface. The processor, memory, and network interface can be connected by a system bus. The system bus is, for example, an Inter-integrated Circuit (I2C) bus.

In some embodiments, the processor may be an Micro-controller Unit (MCU), Central Processing Unit (CPU), Digital Signal Processor (DSP), or the like.

In some embodiments, the memory may be a Flash chip, Read-Only Memory (ROM), disk, optical disc, USB flash drive, portable hard disk, or the like.

The network interface is used for network communication, such as sending out assigned tasks and so on. Those skilled in the art can understand that the structure shown in FIG. 6 is merely a block diagram of some of the structures related to the solution of this application, and does not constitute a limitation on the computer device to which the solution of this application is applied. The specific computer device may include more or fewer components than those shown in the figure, or combine certain components, or have different component arrangements.

Wherein the processor is configured to execute the computer program stored in the memory, and when the computer program is executed by the processor, the steps of the address programming method for LED beads provided by any embodiment of this application can be implemented.

Controlling the LED bead to emit light according to the initial address, and when an initial address corresponds to multiple LED beads that are emitting light, determining that the initial address is a duplicate address;

Replacing initial addresses of the multiple LED beads corresponding to the duplicate address with new initial addresses, such that each initial address corresponds to a single light-emitting LED bead;

Acquiring image information of each LED bead during light emission, and acquiring position information of each LED bead relative to the preset substrate according to the image information; and

Generating the programmed address of the LED bead according to the position information of the LED bead, and programming the programmed address into the LED bead according to the initial address of the LED bead.

It should be noted that those skilled in the art can clearly understand that, for the sake of convenience and conciseness of description, the specific working process of the computer device described above can refer to the corresponding process in the address programming method for LED beads described above, and will not be repeated here.

In an embodiment of this application, a computer-readable storage medium is also provided. The computer-readable storage medium stores a computer program, and the computer program includes program instructions. When the processor executes the program instructions, the steps of the address programming method for LED beads provided in the above embodiments are implemented. For example, when the computer program is loaded by the processor, the following steps can be executed:
controlling the LED bead to emit light according to the initial address, and when an initial address corresponds to multiple LED beads that are emitting light, determining that the initial address is a duplicate address;
replacing initial addresses of the multiple LED beads corresponding to the duplicate address with new initial addresses, such that each initial address corresponds to a single light-emitting LED bead;
acquiring image information of each LED bead during light emission, and acquiring position information of each LED bead relative to the preset substrate according to the image information; and
generating the programmed address of the LED bead according to the position information of the LED bead, and programming the programmed address into the LED bead according to the initial address of the LED bead.

For detailed implementation of the above operations, reference may be made to the foregoing embodiments, and details are not repeated herein.

Wherein the computer-readable storage medium can be an internal storage unit of the aforementioned computer device, such as the hard disk drive or memory of the computer device. The computer-readable storage medium can also be an external storage device of the computer device, such as a pluggable hard disk drive, a smart media card (SMC), a secure digital (SD) card, a flash card equipped on the computer device.

Since the computer program stored in the computer-readable storage medium can execute any one of the address programming methods for LED beads provided by embodiments of this application, it can achieve the beneficial effects that can be achieved by any one of the address programming methods for LED beads provided by embodiments of this application. For details, reference may be made to the foregoing embodiments, and details are not repeated herein.

The serial numbers of the foregoing embodiments of this application are for description only and do not represent the merits of the embodiments. The above are merely specific implementations of this application, but the protection scope of this application is not limited thereto. Any person skilled in the art may readily conceive various equivalent modifications or replacements within the technical scope disclosed by this application, and such modifications or replacements shall fall within the protection scope of this application. Therefore, the protection scope of this application shall be subject to the protection scope of the claims.

What is claimed is:

1. An address programming method for LED beads, configured to program a programmed address into a plurality of LED beads mounted on a preset substrate, and each of the plurality of LED beads is pre-programmed with an initial address; the method comprises:
controlling the LED bead to emit light according to the initial address, and when an initial address corresponds to multiple LED beads that are emitting light, determining that the initial address is a duplicate address;
replacing initial addresses of the multiple LED beads corresponding to the duplicate address with new initial addresses, such that each initial address corresponds to a single light-emitting LED bead;
acquiring image information of each LED bead during light emission, and acquiring position information of each LED bead relative to the preset substrate according to the image information; and
generating the programmed address of the LED bead according to the position information of the LED bead, and programming the programmed address into the LED bead according to the initial address of the LED bead.

2. The address programming method for LED beads according to claim 1, wherein a bit length of the programmed address is less than that of the initial address; the generating the programmed address of the LED bead according to the position information of the LED bead comprises:
sorting position information corresponding to the plurality of LED beads in a preset order;
generating a plurality of sequentially arranged programmed addresses according to a first preset quantity;
wherein the first preset quantity is a total number of the plurality of LED beads, or the first preset quantity is a preset threshold, and the preset threshold is less than the total number of the plurality of LED beads.

3. The address programming method for LED beads according to claim 2, wherein the preset substrate comprises a plurality of LED strips arranged side by side, and each of the plurality of LED strips comprises at least two LED beads;
the generating the programmed address of the LED bead according to the position information of the LED bead comprises:
sorting the position information of the at least two LED beads corresponding to the LED strip in the preset order;
generating the plurality of sequentially arranged programmed addresses according to the first preset quantity;
wherein the first preset quantity is a total number of the at least two LED beads in the LED strip, or the first preset quantity is the preset threshold, wherein the preset threshold is less than the total number of the at least two LED beads in the LED strip; the programmed addresses are programmed into the at least two sorted LED beads of each LED strip according to the initial addresses.

4. The address programming method for LED beads according to claim 3, wherein the LED strip comprises at least LED strip 1 and LED strip 2, a programming order of the programmed address of LED strip 1 is reversed relative to that of LED strip 2.

5. The address programming method for LED beads according to claim 2, wherein before sorting position information corresponding to the plurality of LED beads in a preset order, the method further comprises:
acquiring an arrangement corresponding to the plurality of LED beads according to their position information; and
determining a preset order corresponding to the plurality of LED beads according to the arrangement.

6. The address programming method for LED beads according to claim 1, wherein before controlling the LED bead to emit light according to the initial address, the method further comprises:
programming the initial address into the LED bead in a tape-out testing stage, circuit probing stage or final test stage during a preparation process of the LED bead.

7. The address programming method for LED beads according to claim 6, wherein the programming the initial address into the LED bead comprises:
during the circuit probing stage of the LED bead, programming the initial address into a control chip of the LED bead on a wafer via probe contact; and
dicing the wafer into an individual-shaped control chip, and performing electrical connection and integrated packaging between the individual-shaped control chip and a light-emitting die of the LED bead, to form a package structure corresponding to the LED bead.

8. The address programming method for LED beads according to claim 6, wherein in the final test stage of the LED bead, the plurality of LED beads are packaged in carrier tape; the programming the initial address into the LED bead comprises:
in the final test stage of the LED bead, generating a plurality of initial addresses according to a second preset quantity; and
programming the plurality of initial addresses into the plurality of LED beads packaged in carrier tape according to a preset order.

9. The address programming method for LED beads according to claim 8, wherein the programming the plurality of initial addresses into the plurality of LED beads packaged in carrier tape according to a preset order comprises:
programming the plurality of initial addresses into the plurality of LED beads packaged in carrier tape in descending order.

10. The address programming method for LED beads according to claim 1, wherein the initial address comprises initial address information and first marking information, the first marking information is located at a head or a tail of the initial address;
the programming the programmed address into the LED bead according to the initial address of the LED bead comprises:
programming the programmed address into the LED bead according to the initial address of the LED bead;
wherein the programmed address comprises programmed address information and second marking information, the second marking information is located at the head of the initial address or a tail of the programmed address.

11. The address programming method for LED beads according to claim 1, wherein the replacing initial addresses of the multiple LED beads corresponding to the duplicate address with new initial addresses comprises:
sending high-level instructions to host computer programs corresponding to the multiple LED beads, so that the multiple LED beads enter a duplicate address verification state
sending erase address instructions to the multiple LED beads corresponding to the duplicate address to erase initial addresses programmed in the multiple LED beads corresponding to the duplicate address;
regenerating new initial addresses which are different from initial addresses of the remaining LED beads with non-duplicate addresses; and
programming the new initial addresses into the multiple LED beads corresponding to the duplicate address.

12. The address programming method for LED beads according to claim 11, wherein before replacing initial addresses of the multiple LED beads corresponding to the duplicate address with new initial addresses, the method further comprises:
acquiring image information of a single light-emitting LED bead corresponding to a non-duplicate initial address during light emission, and acquiring position information of the LED bead with a non-duplicate address relative to the preset substrate according to the image information; and
generating the programmed address for the LED bead according to the position information of the LED bead with the non-duplicate address, and programming the programmed address into the LED bead according to the initial address of the LED bead with the non-duplicate address, to make the initial address the same as those of the remaining LED beads.

13. The address programming method for LED beads according to claim 11, wherein the regenerating new initial addresses comprises:
controlling a voltage oscillation of an address generator corresponding to the initial address to change an operating frequency of the address generator, so as to generate different initial addresses when the address generator is powered on.

14. The address programming method for LED beads according to claim 11, wherein the regenerating new initial addresses further comprises:
powering off an address generator corresponding to the initial address;
changing an operating voltage of the address generator to alter its frequency; and
controlling the address generator to power on again so that the address generator generates a new initial address.

15. The address programming method for LED beads according to claim 1, wherein the programming the programmed address into the LED bead according to the initial address of the LED bead comprises:
programming the programmed address and a backup address corresponding to the programmed address into the LED bead according to the initial address of the LED bead.

16. The address programming method for LED beads according to claim 1, wherein the acquiring image information of each LED bead during light emission comprises:
controlling an image acquisition device to face the preset substrate for imaging, in order to acquire image information when controlling each LED bead to emit light according to its corresponding initial address.

17. The address programming method for LED beads according to claim 16, wherein when acquiring the image information, the preset substrate is placed in a dark chamber, so that the image information is used to reflect the position information of the light-emitting LED bead.

18. (canceled)

19. A computer device, comprising a processor and memory, the memory is configured to store a computer program, when the computer program is executed by the processor, the steps of the address programming method for LED beads according to claim 1 are implemented.

20. A computer-readable storage medium, configured to store a computer program, the computer program comprises a program instruction, when the program instruction is executed by a processor, the steps of the address programming method for LED beads according to claim 1 are implemented.

21. The address programming method for LED beads according to claim 5, wherein the acquiring an arrangement corresponding to the plurality of LED beads according to their position information comprises:
inputting coordinates corresponding to the position information of the plurality of LED beads into a preset order prediction model, so that the order prediction model outputs an arrangement.
